(19) United States
(12) Patent Application Publication
(10) Pub. No.: US 2017/0289229 A1
(43) Pub. Date: Oct. 5, 2017

(54) METHOD AND TERMINAL DEVICE FOR PROVIDING MULTIMEDIA CONTENT

(71) Applicants: Le Holdings (Beijing) Co., Ltd., Beijing (CN); LeCloud Computing Co., Ltd., Beijing (CN)

(72) Inventor: Xiaoguang Xu, Beijin (CN)

(21) Appl. No.: 15/242,527

(22) Filed: Aug. 21, 2016

Related U.S. Application Data
(63) Continuation of application No. PCT/CN2016/089539, filed on Jul. 10, 2016.

(30) Foreign Application Priority Data
Mar. 31, 2016 (CN) 2016102018579

(51) Int. Cl. H04L 29/06; H04N 21/234; H04L 29/08

(52) U.S. Cl. CPC H04L 65/602; H04L 67/02; H04N 21/234

(57) ABSTRACT

Embodiments of the present disclosure disclose and provide a method and terminal device for providing multimedia content. The method for providing multimedia content includes: receiving a download request for multimedia content from a client; generating a first predetermined quantity of download information items according to the download request, where the download information items include download addresses of content slices of the multimedia content respectively, and the first predetermined quantity of content slices are a beginning first quantity of content slices of the multimedia content; and sending the first quantity of download information items to the client. A playing starting speed of multimedia content can be increased by means of this method.

### CROSS-REFERENCE TO RELATED APPLICATIONS

The present disclosure is a continuation of PCT application No. PCT/CN2016/089539 submitted on Jul. 10, 2016, and claims priority to Chinese Patent Application No. 2016102018579, filed with the Chinese Patent Office on Mar. 31, 2016 and entitled “METHOD, SERVER, AND TERMINAL DEVICE FOR PROVIDING MULTIMEDIA CONTENT”, which is incorporated herein by reference in its entirety.

### TECHNICAL FIELD

The present patent disclosure relates to network multimedia content speedup technologies, and in particular, to a method and terminal device for providing multimedia content.

### BACKGROUND

HLS (HTTP Live Streaming) is a dynamic bit rate adaption technology. The technology is mainly applied to the streaming media playing field. In an HLS based audio/video service, a server end provides an index file (M3U8 list), and performs slicing and encryption on media content. when playing a streaming media, a client obtains the index file from the server, and obtains file slices by parsing the index file, and finally performs playing.

In a process of playing audio/video content, a response speed of a player has a relatively great effect on user experience. Especially when playing is started, a fast playing starting speed brings relatively good user experience; if the first frame cannot be seen before waiting of more than ten seconds, user experience is poor.

### SUMMARY

An objective of the present invention provides a method and terminal device for providing multimedia content, which can increase a multimedia content playing speed.

To achieve the foregoing objective, according to a first aspect, an embodiment of the present disclosure provides a method for providing multimedia content, where the method includes: receiving a download request for multimedia content from a client; generating a first predetermined quantity of download information items according to the download request, where the download information items include download addresses of content slices of the multimedia content respectively, and the first predetermined quantity of content slices are a beginning first quantity of content slices of the multimedia content; and sending the first quantity of download information items to the client.

In an embodiment, the processing of generating a first predetermined quantity of download information items according to the download request includes: generating a second quantity of download information items according to the download request, where content slices indicated by the second quantity of download information items constitute entire content of the multimedia content; and selecting the beginning first quantity of download information items from the second quantity of download information items.

In an embodiment, the method further includes: after a first predetermined duration, sending remaining download information items in the second quantity of download information items other than the first quantity of download information items to the client at a time or at multiple times.

In an embodiment, the method further includes: after a second predetermined duration, generating a third quantity of download information items according to the download request, where a sum of the third quantity and the first quantity is a total quantity of content slices of the multimedia content, and sending the third quantity of download information items to the client at a time or at multiple times.

In an embodiment, the content slices are transport stream slices based on HTTP Live Streaming, and the download information items are items in an M3U8 index.

According to a second aspect, an embodiment of this disclosure provides a method for providing multimedia content, where the method includes: sending a download request for multimedia content to a server; receiving a first predetermined quantity of download information items, where the download information items include download addresses of content slices of the multimedia content respectively, and the first predetermined quantity of content slices are a beginning first quantity of content slices of the multimedia content; downloading corresponding content slices according to the first quantity of download information items respectively; and performing splicing on downloaded content slices, and playing a spliced content slice.

In an embodiment, the method further includes: receiving remaining download information items, where the remaining download information items include download addresses of content slices of the multimedia content other than the beginning first quantity of content slices respectively; and downloading corresponding content slices according to the remaining download information items respectively.

In an embodiment, the content slices are transport stream slices based on HTTP Live Streaming, and the download information items are items in an M3U8 index.

According to a third aspect, an embodiment of this disclosure provides a non-volatile computer storage medium, which stores computer executable instructions, where the computer executable instructions are used to execute the foregoing method for providing multimedia content, which is based on a terminal, of this disclosure.

According to a fourth aspect, an embodiment of this disclosure provides a terminal device, including: at least one processor; and a memory communicably connected with the at least one processor for storing instructions executable by the at least one processor, where execution of the instructions by the at least one processor causes the at least one processor to execute the foregoing method for providing multimedia content, which is based on a terminal, of this disclosure.

According to the method for providing multimedia content provided in the embodiments of the present disclosure, multimedia content is sliced, and download addresses of content slices are stored by using download information items, and when a client issues a download request, download information items corresponding to a beginning first quantity of content slices are sent to the client, so as to increase a receiving and processing speed of the client, and thereby achieving an objective of fast starting playing.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a method for providing multimedia content according to a first embodiment of the present disclosure;

FIG. 2 is a flowchart of a method for providing multimedia content according to a second embodiment of the present disclosure;

FIG. 3 is a flowchart of a method for providing multimedia content according to a third embodiment of the present disclosure;

FIG. 4 is a flowchart of a method for providing multimedia content according to a fourth embodiment of the present disclosure;

FIG. 5 is a flowchart of a method for providing multimedia content according to a fifth embodiment of the present disclosure;

FIG. 6 is a schematic diagram of a server for providing multimedia content and a terminal device for providing multimedia content according to a sixth embodiment of the present disclosure;

FIG. 7 is a schematic diagram of a server for providing multimedia content according to a sixth embodiment of the present disclosure;

FIG. 8 is a schematic diagram of a terminal device for providing multimedia content according to a sixth embodiment of the present disclosure; and

FIG. 9 is a schematic structural diagram of hardware of a device for providing multimedia content according to an eighth embodiment of the present disclosure.

### DESCRIPTION OF APPENDED REFERENCE NUMBERS

300: Server; 310: Request receiving module; 320: Item generation module; 330: Sending module; 400: Client; 410: Request sending module; 420: Download item receiving module; 430: Download processing module; 440: Playing module.

### DETAILED DESCRIPTION

A basic disclosed conception of the present disclosure is to provide a multimedia content playing manner, in which when a user issues a playing request for multimedia content, and when receiving the playing request, a server end sends download information items of only content slices of a beginning part of the requested multimedia content (instead of download information items of all content slices) to a playing client, so that the playing client starts downloading and playing the multimedia content as soon as possible, so as to increase a receiving and processing speed of the client, and thereby achieving an objective of fast starting playing.

### Embodiment 1

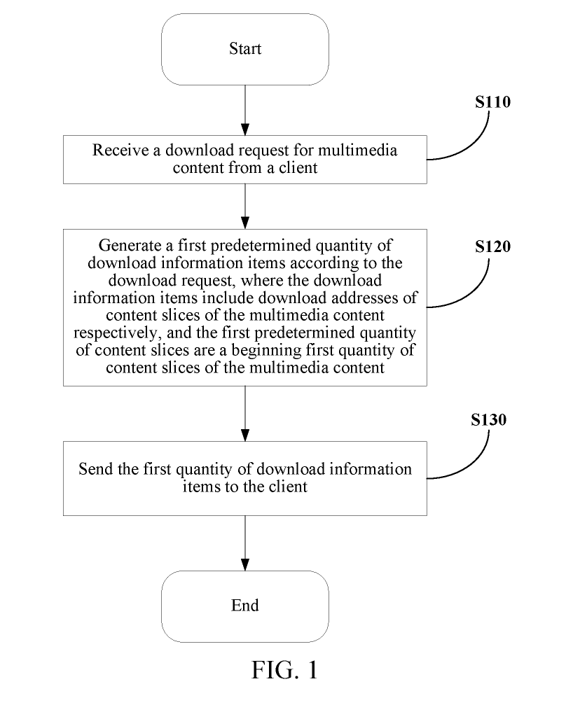

FIG. 1 is a flowchart of a method for providing multimedia content according to the present disclosure. The method may be executed by an apparatus having a data processing capability. The apparatus may be an independent apparatus, or may be integrated in a server.

Refer to FIG. 1. Step S110: Receive a download request for multimedia content from a client.

The multimedia content may be a video, audio, or audio and video, or the like. When using a terminal device, a user issues instructions, for example, playing a video, to a client by using an input device. After receiving these instructions, the client performs processing according to requirements of the instructions, for example, searches a resource locally or sends a download request for the multimedia content to a server. The download request is transferred through a network to the server and received by the server.

Step S120: Generate a first predetermined quantity of download information items according to the download request, where the download information items include download addresses of content slices of the multimedia content respectively, and the first predetermined quantity of content slices are a beginning first quantity of content slices of the multimedia content.

After receiving the download request, the server responses to the download request, for example, searches the multimedia content according to the download request. Generally, to ensure reliability of transfer of the multimedia content, and to improve a load capacity of the server, the server does not directly feed the multimedia content back to the client, but sends a download address of the multimedia content to the client instead.

In this embodiment, transfer of the multimedia content between the server and the client is based on an HTTP Live Streaming protocol, that is, HLS protocol. When the multimedia content is transferred based on this protocol, slicing processing is performed on the multimedia content, so that the multimedia content is turned into multimedia content formed by multiple content slices in a chronological order. After receiving the download request, the server generates a first predetermined quantity of download information items according to the download request. Each download information item includes a download address of one content slice, and content slices corresponding to the first quantity of download information items are a beginning first quantity of content slices of the multimedia content. For example, the first quantity is 10. Then the 10 download information items are corresponding to the first 10 content slices of the multimedia content.

Step S130: Send the first quantity of download information items to the client.

For example, the server may send the first quantity of download information items to the client after generating the first quantity of download information items.

In a case of the HLS protocol, the server generates an M3U8 index, and sends the M3U8 index to the client. Items in the M3U8 index are the first quantity of download information items.

Download addresses corresponding to beginning content slices of multimedia content are first sent to a client, which can reduce a size of a slice index received when playing is started at the client, and thereby increase a receiving speed and an index processing speed of the client. Moreover, a response time interval for a download request at a server end is shorter, which further reduces time used from issuing instructions by a user to responding to the instructions by the client. Thereby, a waiting time of the user is shorter, and user experience is better.

### Embodiment 2

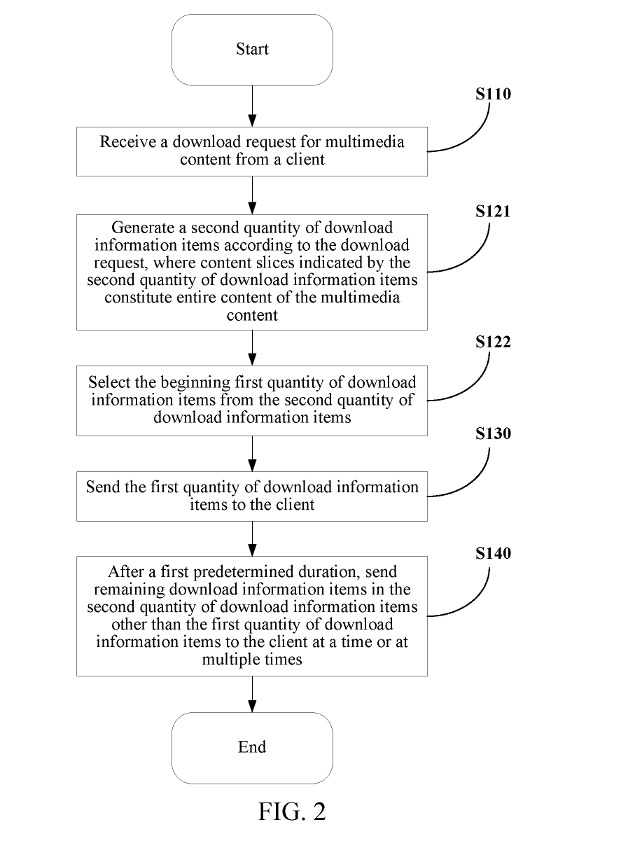

FIG. 2 is a flowchart of a method for providing multimedia content according to the present disclosure. In Embodiment 2, exemplary processing of the generating the first quantity of download information items in step S120 is shown.

S121: Generate a second quantity of download information items according to the download request, where content slices indicated by the second quantity of download information items constitute entire content of the multimedia content. That is, download information items for downloading all content slices constituting the requested multimedia content are generated all at once herein.

Specifically, after receiving the download request, a server allocates, for the client, a resource of a download node server, then performs slicing on the multimedia content according to a time length (or a file size, or the like) of the multimedia content, and generates download information items for download addresses of all content slices, where a quantity of all download information items is a second quantity herein.

Step S122: Select the first quantity of download information items, generated for a beginning part of the multimedia content, from the second quantity of download information items.

For example, after the second quantity of download information items are generated, the beginning first quantity of download information items may be selected from the second quantity of download information items, and an M3U8 index is generated. Step S130 is performed thereafter, so that the client receives and parses these download information items as soon as possible, and starts downloading the beginning content slices.

On this basis, the method further includes step S140: After a first predetermined duration, send remaining download information items in the second quantity of download information items other than the first quantity of download information items to the client at a time or at multiple times.

After playing of the multimedia content is started, subsequent content slices may be downloaded and cached during playing, so that the user does not realize a time for waiting. The user feels that playing of the multimedia content is continuous. The remaining download information items other than the first quantity of download information items may be sent to the client at a time (that is, one M3U8 index is generated) or at multiple times (that is, multiple M3U8 indexes are generated) according to a specific size of the remaining download information items and a load capacity of the server. Thereby, all download information items for downloading the multimedia content can be sent to the client, so that the client can download and play the entire multimedia content.

### Embodiment 3

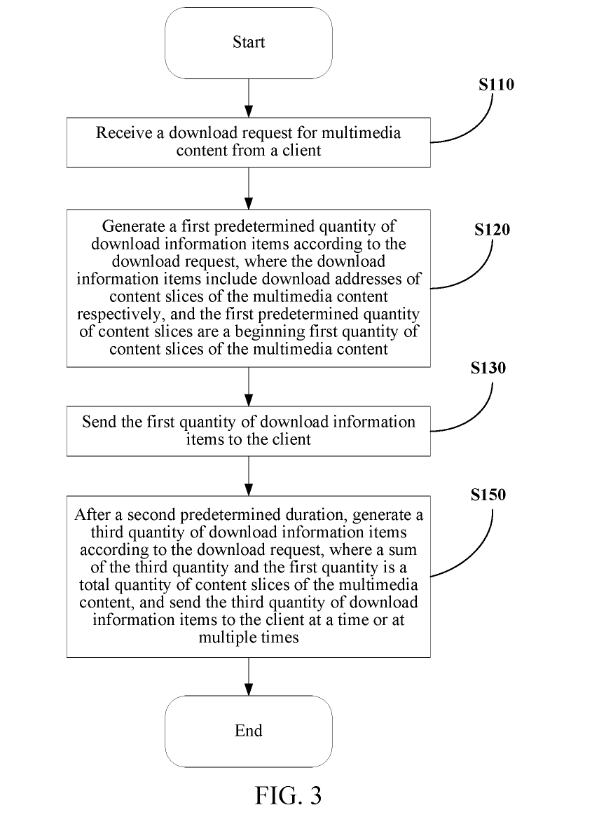

FIG. 3 is a flowchart of a method for providing multimedia content according to the present disclosure. In this embodiment, on the basis of Embodiment 1, after step S120 and step S130, processing in step S150 is further performed.

Specifically, step S150 is: After a second predetermined duration, generate a third quantity of download information items according to the download request, where a sum of the third quantity and the first quantity is a total quantity of content slices of the multimedia content, and send the third quantity of download information items to the client at a time or at multiple times.

In this way, download information items can be generated for download addresses corresponding to the remaining content slices of the multimedia content, so as to ensure that the client can play the entire multimedia content.

The third quantity of download information items may be sent to the client at a time (that is, one M3U8 index is generated) or at multiple times (that is, multiple M3U8 indexes are generated) according to a specific size of the third quantity of download information items and a load capacity of the server. Thereby, the client can play the entire multimedia content.

### Embodiment 4

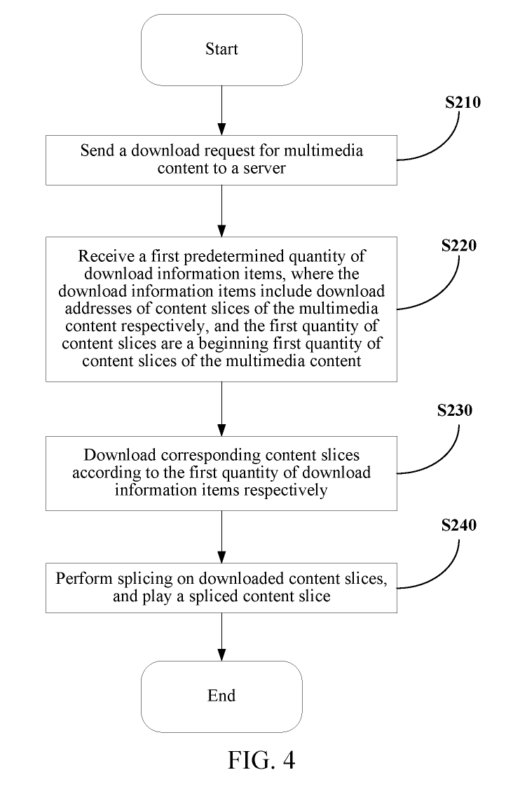

FIG. 4 is a flowchart of a method for providing multimedia content according to the present disclosure. In this embodiment, a client is described in detail.

Step S210: Send a download request for multimedia content to a server.

After a user issues instructions to a playing application, a client of the playing application sends a download request for multimedia content (audio, a video, audio and video, or the like) to a server according to the instructions. The download request may be a playing request or the like.

Step S220: Receive a first predetermined quantity of download information items, where the download information items include download addresses of content slices of the multimedia content respectively, and the first predetermined quantity of content slices are a beginning first quantity of content slices of the multimedia content.

The server returns the first quantity of download information items according to the download request. The client receives the first quantity of download information items, and acquires download addresses of the first quantity of content slices from the first quantity of download information items. The first quantity of download information items should be a beginning first quantity (that is, from the first to the first-quantity^{th}) of content slices of the multimedia content. If the first quantity is 10, the first quantity of content slices should be the first content slice to the tenth content slice.

S230: Download corresponding content slices according to the first quantity of download information items respectively.

After receiving the first quantity of download information items, the client performs processing on the first quantity of download information items, for example, parses and decrypts the first quantity of download information items. Finally, the content slices are downloaded according to the download information items.

Step S240: Perform splicing on downloaded content slices, and play a spliced content slice.

After the content slices are downloaded, the content slices are spliced, so that the content slices are turned into a file that can be played, and a spliced content slice is played.

### Embodiment 5

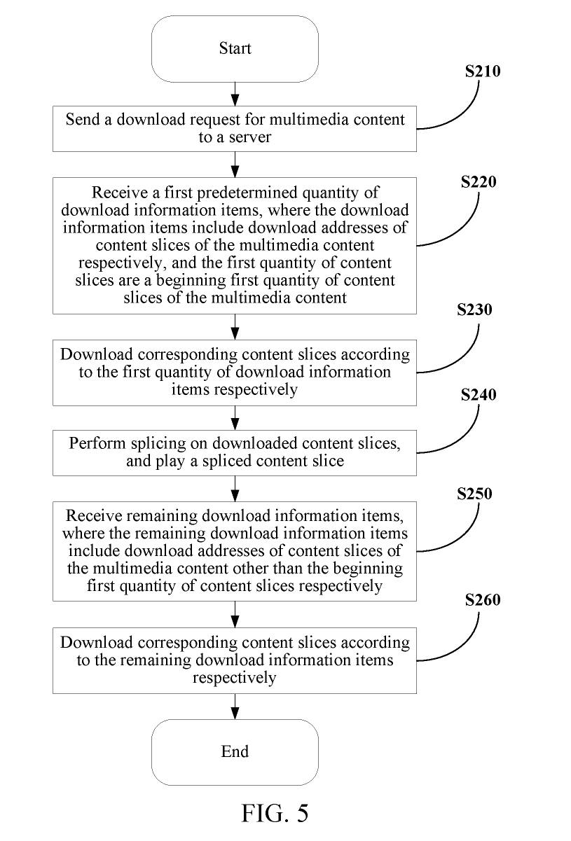

FIG. 5 is a flowchart of a method for providing multimedia content according to the present disclosure. In this embodiment, a client downloads a first quantity of content slices, and after the first quantity of content slices are played, processing in step S250 and step S260 is performed.

Specifically, step S250: Receive remaining download information items, where the remaining download information items include download addresses of content slices of the multimedia content other than the beginning first quantity of content slices respectively.

To ensure that the multimedia content can be continuously and entirely played, the server sends download information items corresponding to remaining content slices to the client at a time or at multiple times. The client receives the remaining download information items.

Step S260: Download corresponding content slices according to the remaining download information items respectively.

After receiving the remaining download information items, the client performs processing on the remaining download information items, and finally acquires corresponding content slices. Thereafter, processing such as splicing, storage, reading, and playing may be performed on the content slices according to needs.

In this embodiment, the content slices are transport stream slices based on HTTP Live Streaming (HLS protocol), and the download information items are items in an M3U8 index. The client receives an index that is an M3U8 index. The M3U8 index includes the first quantity of download information items or the remaining quantity of download information items.

### Embodiment 6

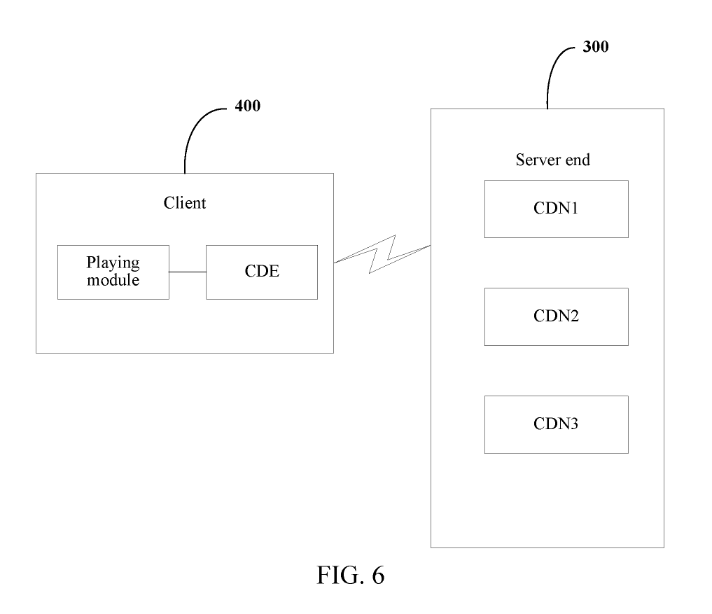

FIG. 6 is a schematic diagram of a server for providing multimedia content and a terminal device for providing multimedia content according to the present disclosure. In this embodiment, a client 400 is a playing application provided on the terminal device. The server 300 is a cloud server. Generally, the playing application, that is, the client 400 includes a playing module for playing multimedia content and a cloud data entry (CDE module, Cloud Data Entry) for data transfer and processing with a cloud. The server 300 includes multiple server nodes (CDN) and a scheduling server.

The client 400 transfers a request to one of the server nodes of the server 300. The server node transfers the request to the scheduling server. The scheduling server sends a download information item to the client 400 according to the request by using the foregoing method for providing multimedia content, and the client 400 receives and processes the download information item.

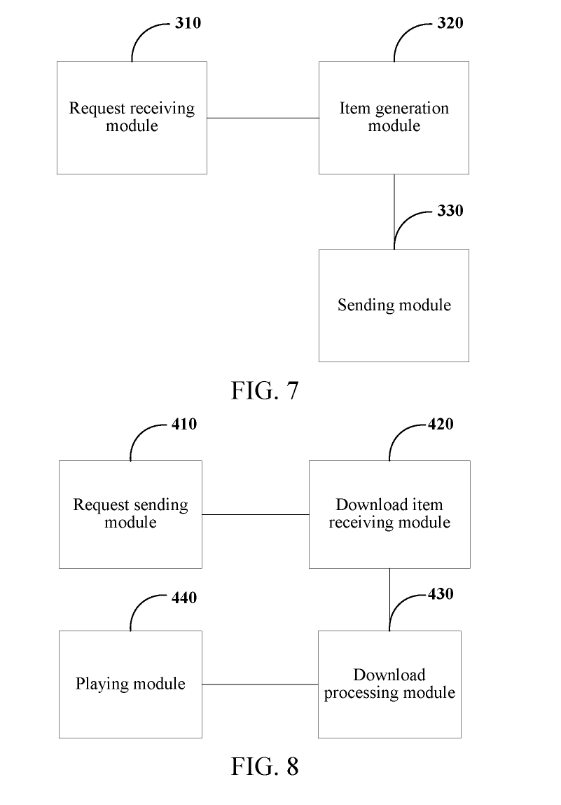

Specifically, FIG. 7 is a schematic diagram of a server for providing multimedia content according to the present disclosure. As shown in FIG. 7, a server for providing multimedia content includes a request receiving module 310, an item generation module 320, and a sending module 330.

The request receiving module 310 is configured to receive a download request for multimedia content. The request receiving module 310 may be set on any server node, or may set on the scheduling server.

The item generation module 320 is configured to generate a first predetermined quantity of download information items according to the download request, where the download information items include download addresses of content slices of the multimedia content respectively, and the first predetermined quantity of content slices are a beginning first quantity of content slices of the multimedia content. The item generation module 320 is set on the scheduling server in this embodiment. The scheduling server schedules resources according to load and resource statuses of the server nodes of the entire cloud server, and generates, according to a transfer protocol between the server and the client, corresponding download information items including download addresses of content slices. This embodiment is based on an HLS protocol. Therefore, the item generation module 320 generates an M3U8 index including download information items.

Certainly, in other embodiments, the item generation module 320 may be set on any server node. A form of the download information item is not limited to an M3U8 index.

The sending module 330 is configured to send the generated first quantity of download information items to the client.

Multiple manners in which the item generation module 320 generates the first quantity of download information items may exist. For example, the item generation module 320 may generate a second quantity of download information items according to the download request, where content slices indicated by the second quantity of download information items constitute entire content of the multimedia content, and then the item generation module obtains, by cutting, the beginning first quantity of download information items from the second quantity of download information items.

Certainly, the item generation module may also first generate the first quantity of download information items and then generate a third quantity of download information items, where a sum of the third quantity and the first quantity is a total quantity of content slices of the multimedia content.

FIG. 8 is a schematic diagram of a terminal device for providing multimedia content according to the present disclosure. A terminal device for providing multimedia content is shown in FIG. 8. The apparatus includes a request sending module 410, a download item receiving module 420, a download processing module 430, and a playing module 440.

The request sending module 410 is configured to send a download request for multimedia content. The request sending module 410 is set in the CDE module of the client. The request sending module 410 sends different requests according to instructions of a user.

The download item receiving module 420 is configured to receive a first quantity of download information items, where the download information items include download addresses of content slices of the multimedia content respectively, and the first predetermined quantity of content slices are a beginning first quantity of content slices of the multimedia content. The download item receiving module 420 is also set in the CDE module of the client.

The download processing module 430 is configured to: after the download item receiving module 420 receives the download information items, download corresponding content slices according to the first quantity of download information items respectively, and perform splicing on downloaded content slices. For example, after the download item receiving module 420 receives an M3U8 index, the download processing module 430 performs processing on the M3U8 index, downloads content slices according to download addresses in the M3U8 index, and performs processing on the content slices by using a description on a time line in the M3U8.

The playing module 440 is configured to play multimedia content spliced by the download processing module 430. The download processing module 430 transfers processed multimedia content to the playing module 440, and the playing module 440 performs processing such as decoding on the multimedia content for playing.

The item generation module 320 performs slicing processing on the multimedia content, and sends download information items of all content slices at at least two times. Therefore, the download item receiving module 420 is further configured to receive remaining download information items other than the first quantity of download information items, where the remaining download information items include download addresses of content slices of the multimedia content other than the beginning first quantity of content slices respectively.

The download processing module 430 is further configured to download corresponding content slices according to the remaining download information items respectively. If the remaining content slices downloaded by the download processing module 430 are not played and used, these content slices are stored first.

Thereby, in a multimedia transfer process based on an HLS protocol, beginning several items in a generated M3U8 index are sent to a client first at a server end, instead of sending all items to the client at a time, which is simple to implement, and can significantly increase a playing starting speed of multimedia content of the client, and improve user experience. It is to be noted that, the method is especially suitable for an on-demand playing process.

### Embodiment 7

Embodiment 7 of this disclosure provides a non-volatile computer storage medium, which stores computer executable instructions, where the computer executable instructions can execute the method for providing multimedia content provided in the foregoing fourth or fifth method embodiment.

### Embodiment 8

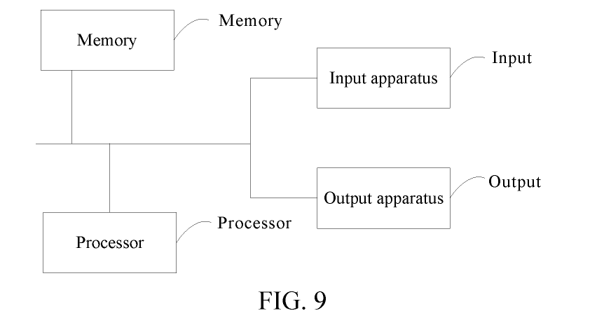

FIG. 9 is a schematic structural diagram of hardware of a device for providing multimedia content in Embodiment 8 of the present disclosure. As shown in FIG. 9, the electronic device includes:

one or more processors and a memory, where only one processor is used as an example in FIG. 9.

A server for executing the multimedia recommendation method based on an Android platform may further include: an input apparatus and an output apparatus.

The processor, the memory, the input apparatus, and the output apparatus can be connected by means of a bus or in other manners. A connection by means of a bus is used as an example in FIG. 9.

As a non-volatile computer readable storage medium, the memory 520 can be used to store non-volatile software programs, non-volatile computer executable programs and modules, for example, program instructions/module (for example, the request sending module 410, the download item receiving module 420, the download processing module 430, and the playing module 440 shown in FIG. 8) corresponding to the method for providing multimedia content in the embodiments of this disclosure. The processor executes various functional applications and data processing of the server, that is, implements the method for providing multimedia content of the foregoing method embodiments, by running the non-volatile software programs, instructions, and modules that are stored in the memory.

The memory may include a program storage area and a data storage area, where the program storage area may store an operating system and an application that is needed by at least one function; the data storage area may store data created according to use of the multimedia recommendation apparatus, and the like. In addition, the memory may include a high-speed random access memory, or may also include a non-volatile memory such as at least one disk storage device, flash storage device, or another non-volatile solid-state storage device. In some embodiments, the memory optionally includes memories that are remotely disposed with respect to the processor, and the remote memories may be connected, via a network, to the terminal device for providing multimedia content. Examples of the foregoing network include but are not limited to: the Internet, an intranet, a local area network, a mobile communications network, or a combination thereof.

The input apparatus can receive entered digits or character information, and generate key signal inputs relevant to user setting and functional control of the terminal device for providing multimedia content. The output apparatus may include a display device, for example, a display screen.

The one or more modules are stored in the memory; when the one or more modules are executed by the one or more processors, the method for providing multimedia content in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

What is claimed is:

1. A method for providing multimedia content, applied to a server, comprising:
receiving a download request for multimedia content from a client;
generating a first predetermined quantity of download information items according to the download request, wherein the download information items comprise download addresses of content slices of the multimedia content respectively, and the first predetermined quantity of content slices are a beginning first quantity of content slices of the multimedia content; and
sending the first quantity of download information items to the client.

2. The method according to claim 1, wherein the processing of generating a first predetermined quantity of download information items according to the download request comprises:
generating a second quantity of download information items according to the download request, wherein content slices indicated by the second quantity of download information items constitute entire content of the multimedia content; and
selecting the beginning first quantity of download information items from the second quantity of download information items.

3. The method according to claim 2, wherein the method further comprises:
after a first predetermined duration, sending remaining download information items in the second quantity of download information items other than the first quantity of download information items to the client at a time or at multiple times.

4. The method according to claim 1, wherein the method further comprises:
after a second predetermined duration, generating a third quantity of download information items according to the download request, wherein a sum of the third quantity and the first quantity is a total quantity of content slices of the multimedia content, and sending the third quantity of download information items to the client at a time or at multiple times.

5. The method according to claim 1, wherein the content slices are transport stream slices based on HTTP Live Streaming, and the download information items are items in an M3U8 index.

6. A method for providing multimedia content, comprising:
sending a download request for multimedia content to a server;
receiving a first predetermined quantity of download information items, wherein the download information items comprise download addresses of content slices of the multimedia content respectively, and the first predetermined quantity of content slices are a beginning first quantity of content slices of the multimedia content;
downloading corresponding content slices according to the first quantity of download information items respectively; and
performing splicing on downloaded content slices, and playing a spliced content slice.

7. The method according to claim 6, wherein the method further comprises:
receiving remaining download information items, wherein the remaining download information items comprise download addresses of content slices of the multimedia content other than the beginning first quantity of content slices respectively; and
downloading corresponding content slices according to the remaining download information items respectively.

8. The method according to claim 6, wherein the content slices are transport stream slices based on HTTP Live Streaming, and the download information items are items in an M3U8 index.

9. The method according to claim 7, wherein the content slices are transport stream slices based on HTTP Live Streaming, and the download information items are items in an M3U8 index.

10. A non-volatile computer storage medium, which stores computer executable instructions that, when executed by an electronic device, cause the electronic device to:
send a download request for multimedia content to a server;
receive a first predetermined quantity of download information items, wherein the download information items comprise download addresses of content slices of the multimedia content respectively, and the first predetermined quantity of content slices are a beginning first quantity of content slices of the multimedia content;
download corresponding content slices according to the first quantity of download information items respectively; and
perform splicing on downloaded content slices, and playing a spliced content slice.

11. The non-volatile computer storage medium according to claim 10, wherein the computer executable instructions further cause the electronic device to:
receive remaining download information items, wherein the remaining download information items comprise download addresses of content slices of the multimedia content other than the beginning first quantity of content slices respectively; and
download corresponding content slices according to the remaining download information items respectively.

12. The non-volatile computer storage medium according to claim 10, wherein the content slices are transport stream slices based on HTTP Live Streaming, and the download information items are items in an M3U8 index.

13. A terminal device, comprising:
at least one processor; and
a memory communicably communication with the at least one processor, wherein
the memory stores instructions executable by the at least one processor, wherein
execution of the instructions by the at least one processor causes the at least one processor to:
send a download request for multimedia content to a server;
receive a first predetermined quantity of download information items, wherein the download information items comprise download addresses of content slices of the multimedia content respectively, and the first predetermined quantity of content slices are a beginning first quantity of content slices of the multimedia content;
download corresponding content slices according to the first quantity of download information items respectively; and
perform splicing on downloaded content slices, and playing a spliced content slice.

14. The terminal device according to claim 13, wherein the program further cause the at least one processor to:
receive remaining download information items, wherein the remaining download information items comprise download addresses of content slices of the multimedia content other than the beginning first quantity of content slices respectively; and
download corresponding content slices according to the remaining download information items respectively.

15. The terminal device according to claim 14, the content slices are transport stream slices based on HTTP Live Streaming, and the download information items are items in an M3U8 index.
